(19) United States
(12) Patent Application Publication
(10) Pub. No.: US 2011/0033660 A1
(43) Pub. Date: Feb. 10, 2011

(54) Adhesive Tape for use with a Polymer Substrate

(76) Inventors: Yi Feng, San Diego, CA (US); Sterling Chaffins, Albany, OR (US); Emmet Whittaker, Corvallis, OR (US); Veronica A. Nelson, Albany, OR (US); Brian G. Risch, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/937,923

(22) PCT Filed: Apr. 18, 2008
(86) PCT No.: PCT/US08/60845

§ 371 Date: Oct. 14, 2010

(51) Int. Cl. C09J 7/02; B32B 7/12; B05D 5/10

(52) U.S. Cl. 428/138; 428/336; 427/207.1

(57) ABSTRACT

An adhesive tape has an adhesive material including at least 28% vinyl acetate by weight disposed on a basefilm at a substantially uniform thickness of up to 18 microns. A method of fabricating an adhesive tape includes depositing an adhesive material including at least 28% vinyl acetate by weight on a basefilim at a substantially uniform thickness of up to 18 microns.

### RELATED APPLICATIONS

The present application claims the priority under 35 U.S.C. 119(a)-(d) or (f) and under C.F.R. 1.55(a) of previous International Patent Application No.: PCT/US2008/060845, filed Apr. 18, 2008, entitled “Adhesive Tape for Use with a Polymer Substrate”, which application is incorporated herein by reference in its entirety.

### BACKGROUND

Polymers often prove to be inexpensive and versatile materials for any number of fabrication and manufacturing applications. Polymers can generally be formed into a variety of shapes. Due at least in part to this versatility, polymer materials are often used to create orifices, such as nozzles, through which the flow of liquids may be controlled or manipulated. For example, in inkjet printing applications, many print cartridges have printhead devices that are designed to expel minute droplets of liquid ink in a controlled manner through tiny nozzles formed from a polymer so as to collectively form an image on print media below the print cartridge.

Often print cartridges and other devices having polymer orifices are manufactured and shipped to consumers already primed with the liquid that is to be expelled through the orifices. In many cases, this is done according to the convenience and preference of the consumers. Unfortunately, significant challenges are presented when shipping print cartridges and other devices in this state, as doing so may require preventing the liquid from escaping through the orifice prior to use by the consumer and protecting the liquid from exposure to air or other ambient substances that may dry or contaminate the liquid.

Plastic plugs or caps are sometimes used in polymer orifices to prevent liquid escape and exposure to the ambient environment, but these can be costly and tedious to apply. Adhesive tapes are commonly applied to polymer orifices in printheads for the same purpose. However, it has been found that the adhesives used in these tapes tend to increase in adhesion on polymer substrates over time at ambient and elevated temperatures. This increased adhesion often requires an increased peel force to remove the tape from the orifices, which in turn may result in tearing or other damage to the orifices. Additionally, the adhesives used on some of these tapes are not sufficiently resilient to caustic liquid, such as some inks. This reaction can reduce the adhesion of the tape and cause leaking through the orifice and/or undesirable mixing between liquids from separate nozzles.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of an illustrative inkjet print cartridge, according to one embodiment of the principles described herein.

FIG. 2 is a perspective view of an illustrative printhead device on the print cartridge of FIG. 1, according to one embodiment of the principles described herein.

FIG. 3 is a perspective view of an illustrative inkjet print cartridge with adhesive tape disposed over printhead nozzles, according to one embodiment of the principles described herein.

FIG. 4 is a perspective view of a piece of illustrative adhesive tape being removed from printhead nozzles of an illustrative inkjet print cartridge, according to one embodiment of the principles described herein.

FIG. 5 is a cross-sectional side view of an illustrative adhesive tape for use with a polymer substrate, according to one embodiment of the principles described herein.

FIGS. 6A and 6B are diagrams of interfacial diffusion between an illustrative adhesive layer on a piece of tape and an illustrative printhead polymer material, according to one embodiment of the principles described herein.

FIG. 7 is a graph of experimental peel force delta data in two different types of adhesive tape, according to one embodiment of the principles described herein.

FIG. 8 is a graph of experimental peel force data in two different types of adhesive tape over varied time and temperature, according to one embodiment of the principles described herein.

FIG. 9 is a flowchart of an illustrative method of fabricating an adhesive tape, according to one embodiment of the principles described herein.

Throughout the drawings, identical reference numbers designate similar, but not necessarily identical, elements.

### DETAILED DESCRIPTION

As described above, orifices are often fabricated in a member made of polymer material so as to provide for the controlled disbursement of a liquid, for example, as part of an inkjet print head. In some cases, such as where the print head is primed with ink prior to shipping and initial storage, it may be desirable to inexpensively and effectively seal such orifices until the print head is ready to be deployed.

To accomplish these and other goals, the present specification discloses an adhesive tape for temporarily sealing orifices formed in a polymer material. The adhesive tape described herein advantageously exhibits a minimal increase in adhesion to a polymer substrate over time at ambient and even elevated temperatures. The adhesive tape disclosed herein is also sufficiently chemically resistant to caustic liquids, such as ink, that it maintains adequate adhesion to a polymer material even though sealing orifices in the polymer material that are primed with a caustic liquid. Consequently, the adhesive tape does not allow the liquids to exit the orifice or mix with each other.

In an illustrative embodiment, the adhesive tape includes an adhesive material having at least 28% vinyl acetate by weight disposed on a basefilm at a substantially uniform thickness of up to 18 microns. The adhesive material may have a melt index of at least 20 g/10 min. and been cured by irradiation at a level of at least 110 kGy.

As used in the present specification and in the appended claims, the term “polymer” refers to a compound or mixture of compounds including molecules made up of a linked series of repeated structural units, i.e., monomers. Examples of polymers include, but are not limited to, plastics, epoxies, and photoresist materials.

As used in the present specification and in the appended claims, the term “basefilm” refers to a flexible strip of plastic material upon which adhesive material may be deposited to form an adhesive tape.

As used in the present specification and in the appended claims, the term “peel force” refers to an amount of force required to remove a piece of adhesive tape from a substrate or member where it has been applied.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems and methods. While the illustrative systems and methods will be explained in the context of applications to inkjet print cartridges and printheads, it will be apparent to one skilled in the art that the principles described herein are not limited to use within the realm of inkjet printing systems. Rather, the principles of the present specification may be used in a wide variety of applications in which adhesive tape is applied to a polymer substrate.

### Illustrative Systems

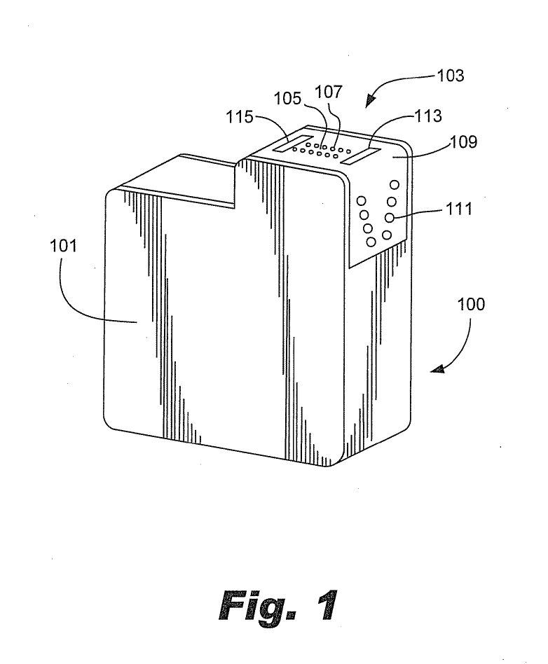

Referring now to FIG. 1, an illustrative inkjet print cartridge (100) according to principles described herein is shown. General features of the illustrative inkjet print cartridge (100) will be described with respect to the present figure to provide a contextual background of one application of the present principles.

The inkjet print cartridge (100) includes an ink reservoir (101) to store a supply of liquid ink within the cartridge (100). A printhead (103) is used to selectively dispense the liquid ink from the reservoir. In some examples, the printhead (103) may be formed using Tape Automated Bonding (TAB), a well-known technique in the art. The printhead (103) may also include a nozzle member (105) having parallel columns of offset holes or orifices (107) formed in a flexible polymer material (109) by, for example, laser ablation. The polymer material (109) may include any polymer or combination of polymers as may suit a particular application, including, but not limited to, epoxy photoresists (e.g. SU-8), Kapton™ tape from 3M Corporation, Upilex®.

A back surface of the polymer material (109) may include conductive traces formed thereon using, for example, a photolithographic etching and/or plating process. These conductive traces may be terminated by large contact pads (111) designed to provide communication with a printer. For example, the print cartridge (100) may be designed to be installed in a printer such that the contact pads (111), on the front surface of the flexible polymer material (109), contact printer electrodes providing control signals to the printhead from the printer.

As mentioned, the aforementioned traces may be formed on the back surface of the flexible polymer material (109) (opposite the surface which faces the recording medium). Holes (vias) may be formed through the front surface of the polymer material (109) to expose the ends of the traces. The exposed ends of the traces may then be plated with, for example, gold to form the contact pads (111) disposed on the front surface of the polymer material (109).

Windows (113, 115) may extend through the polymer material (209) and be used to facilitate bonding of the other ends of the conductive traces to electrodes on a silicon substrate containing heater resistors. The windows (113, 115) may be filled with an encapsulant to protect any underlying portion of the traces and substrate.

In the print cartridge (100) of the present example, the polymer material (109) is bent over the back edge of the print cartridge “snout” and extends approximately one half the length of a back wall of the snout. This flap portion of the polymer material (109) may be useful for the routing of conductive traces which may be connected to the substrate electrodes through the far end window (113).

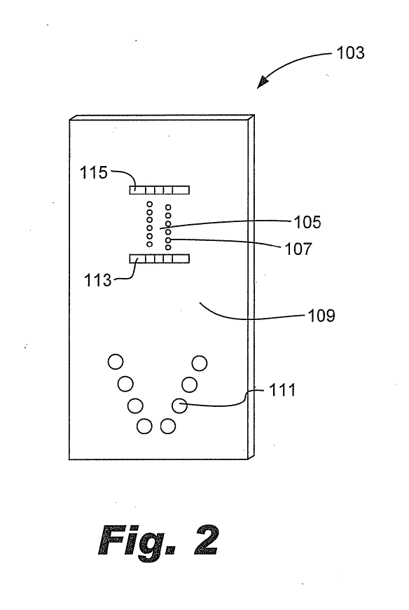

FIG. 2 shows a front view of an illustrative printhead (103), removed from the print cartridge (100). The view of FIG. 2 is prior to the windows (113, 115, FIG. 1) in the printhead (103) being filled with an encapsulant.

A semiconductor die may be affixed to the back of the printhead (103). The die may include a plurality of individually energizable thin film resistors. Each resistor may be located generally behind a single orifice (107) and act as an ohmic heater when selectively energized by one or more pulses applied sequentially or simultaneously to one or more of the contact pads (111). Heat from such a resistor will vaporize a quantity of ink in a firing chamber thereby ejecting a droplet of ink from a corresponding orifice.

The orifices (107) and conductive traces may be of any size, number, and pattern, as suits a particular application. The orifice pattern on the flexible polymer material (109) shown in FIG. 2 may be formed by a masking process in combination with a laser or other etching means according to principles understood by those familiar with the art.

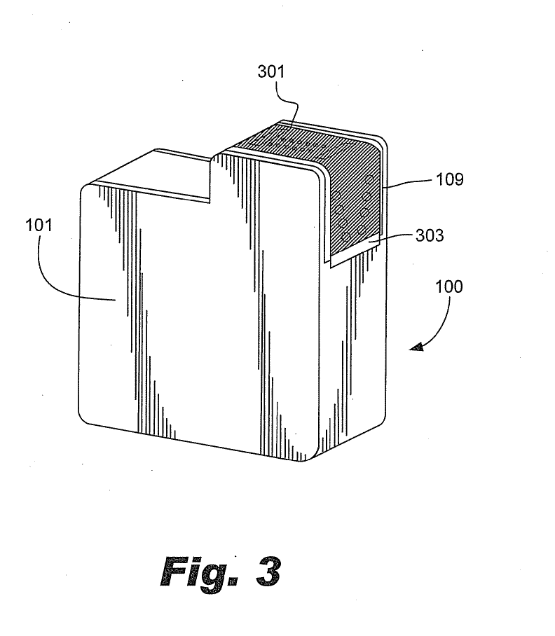

Referring now to FIG. 3, the illustrative ink print cartridge (100) is shown with a strip of adhesive tape (301) applied over the flexible polymer material (109). The adhesive tape (301) may be used to seal the orifices (107, FIG. 1) in the polymer material (109) as the print cartridge (100) is shipped from the manufacturer to a consumer and stored before use.

After a consumer receives the print cartridge (100), he or she may prepare to load the cartridge (100) into a printing device by removing the adhesive tape (301) from the print cartridge (100) to expose the orifices (107, FIG. 1) in the flexible polymer material (109). In some embodiments, the adhesive tape (301) also covers the contact pads (111, FIG. 1) and is removed so that the printing device in which the cartridge (100) is installed may have electrical access to those contact pads (111, FIG. 1). As indicated above, control signals provided to the exposed contact pads (111, FIG. 1) result in ink being selectively expelled through the orifices (107, FIG. 1) to a print medium.

In certain embodiments, a non-adhesive tab (303) may be included on one end of the adhesive tape (301) to assist a user in removing the tape (301) from the flexible polymer material (109). The user can grasp the tab (303) to applying a peel force to remove the tape (301) from the cartridge (100).

The adhesive tape (301) may be fabricated from a hot-melt adhesive deposited on one side of a basefilm. When the adhesive tape (301) is deposited over the flexible polymer material (109) of the print cartridge, it may be intended that the adhesive temporarily bond to the polymer material (109), thus sealing the orifices (107, FIG. 1) of the printhead (103, FIG. 1) and preventing liquid ink from exiting the orifices (107, FIG. 1) prior to use of the print cartridge (100) in a printing device. In this way, a print cartridge (100) may be shipped to a consumer or retailer with liquid ink already in the reservoir (101) such that the printhead (103, FIG. 1) may already be substantially primed and ready to print when the print cartridge (100) is installed in a printing device.

Unfortunately, in many prior art adhesive tapes as noted above, caustic properties of the liquid ink may corrode or degrade the effectiveness of the adhesive of the tape (301), depending on the formulation of the adhesive used in the tape (301) and the type of polymer material (109) used in the print cartridge (100). The result is a loss of adhesion between the tape (301) and the polymer print head (103, FIG. 1), thus allowing ink to escape from the orifices (107, FIG. 1) under the adhesive tape (301) while the tape (301) is still attached to the print cartridge (100).

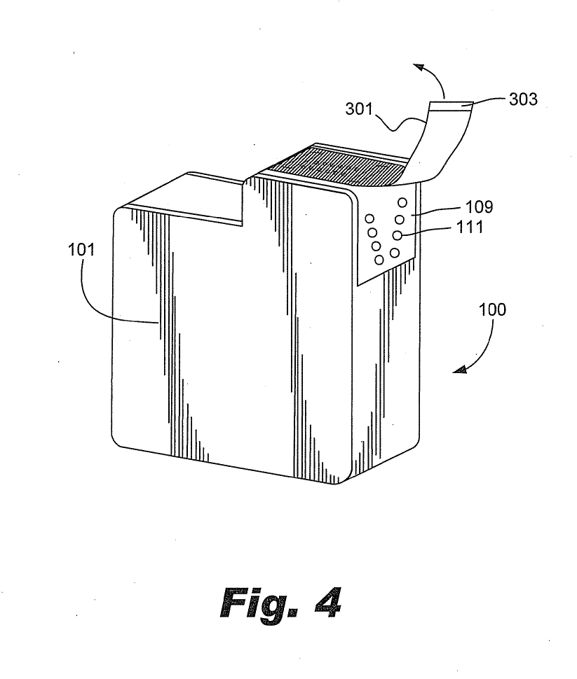

Referring now to FIG. 4, the illustrative print cartridge (100) is shown with the adhesive tape (301) being removed from the polymer material (109). Another issue commonly experienced with prior art adhesive tapes used on polymer substrates is that it is common for the tapes to increase in adhesion to the polymer substrates over time at ambient and elevated temperatures.

This increased adhesion may in turn increase the peel force required to remove the adhesive tape from the polymer substrate. Where the peel force is increased beyond a critical peel force for the polymer substrate, the polymer substrate may experience structural damage, such as tearing, as the adhesive tape is removed from the polymer substrate. This may be detrimental or even debilitating to the structures formed in the polymer material (109), such as the orifices (107, FIG. 1).

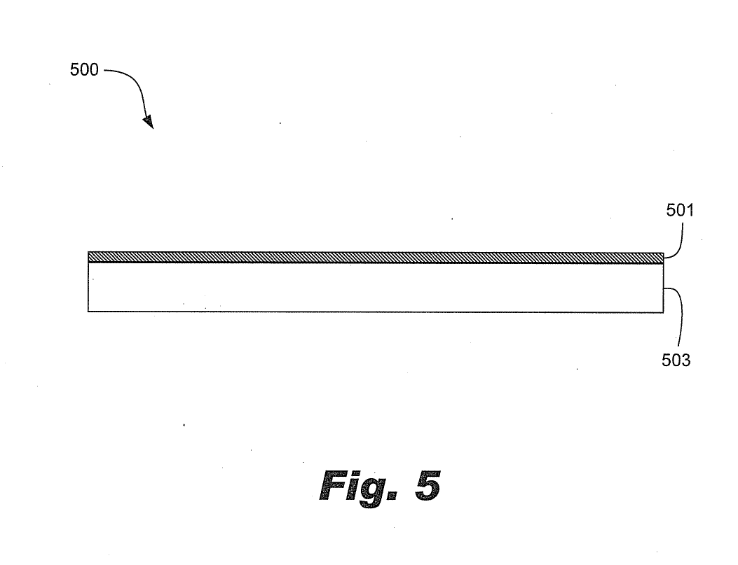

Referring now to FIG. 5, an adhesive tape (500) configured to adhere to a polymer substrate is shown. As described herein, the adhesive tape (500) may be configured to prevent tearing and other structural damage as the tape (500) is removed from the polymer substrate. Additionally, the adhesive tape (500) may be configured to prevent leakage from one or more orifices in the polymer substrate while the adhesive tape (500) is attached to the polymer substrate.

In the illustrated embodiment, the adhesive tape (500) may include a layer of ethylene vinyl acetate (EVA) (501) adhesive disposed on a basefilm (503). The basefilm (503) may include polyolefin or any other flexible material that may suit a particular application of the principles described herein. The layer of EVA (501) may be deposited on the basefilm (503) by hot melt methods or any other method that may suit a particular application.

In the illustrated embodiment, the layer of EVA (501) may include at least 28% by weight vinyl acetate and have a thickness of no more than 18 microns (0.7 mils). The layer of EVA (501) may also include between 65% and 72% ethylene, and have a melt flow index (MFI) of at least 20 g/10 min. Additionally, the EVA (501) may have been cured by irradiation at a level of at least 110 kGy (11 MRad) to induce cross-coupling among the particles in the EVA (501) such that at least a portion of the EVA (501) includes cross-coupled copolymers.

The physical mechanics of adhesion, or more simply the wetting characteristics and adhesive strength of the adhesive material used in the tape, may affect the uniformity of the adhesive material across a polymer substrate. In many prior art adhesive tapes used for polymer substrates, non-uniformity in adhesion has been known to cause localized areas of higher adhesion between the tape and the polymer substrate. The uniformity in adhesion may be affected by, for example, the strength of the adhesive material, the thickness of the adhesive material deposited on the basefilm of the tape, and the “wetness” of the adhesive.

In an ethylene vinyl acetate adhesive (EVA adhesive), it has been found that the uniformity of adhesion can be manipulated by altering the thickness of the adhesive material on the basefilm, the percentage of vinyl acetate used in the adhesive, the melt flow index of the adhesive, and the level of cross-linking between polymer particles in the adhesive. By reducing the thickness of the adhesive material on the basefilm (503), less of the adhesive material (501) in the tape was displaced by contact with different features of the polymer substrate.

Additionally, by increasing the percentage of vinyl acetate used in the EVA (501), the overall adhesion of the EVA (501) was decreased due to an increasing energy of interaction between the EVA (501) and the polymer substrate. Increasing the melt flow index of the EVA adhesive (501) imparted more flow to the melted adhesive as it was deposited on the basefilm, thus giving the tape (500) a more uniform coating of the EVA adhesive (501). Cross-linking the EVA decreased the original melt flow index as received prior to the cross-linking process. The degree to which cross-linking occurs in the adhesive (501) may be used to selectively control the melt flow index.

Numerically speaking, it has been further found that a layer of EVA adhesive (501) having a thickness of no more than 18 microns (0.7 mils), where the adhesive was composed of at least 28% by weight vinyl acetate, having a melt flow index of at least 20 g/10 min, and having been irradiated at a level of at least 110 kGy (11 MRad) to induce cross-coupling in the EVA, had a substantially higher uniformity of adhesion to an SU8 epoxy photoresist substrate than other prior art adhesive tape solutions. This formulation of adhesive material was tested and found to meet the requirements necessary to eliminate the risk of SU8 substrate tearing, as will be explained in more detail below.

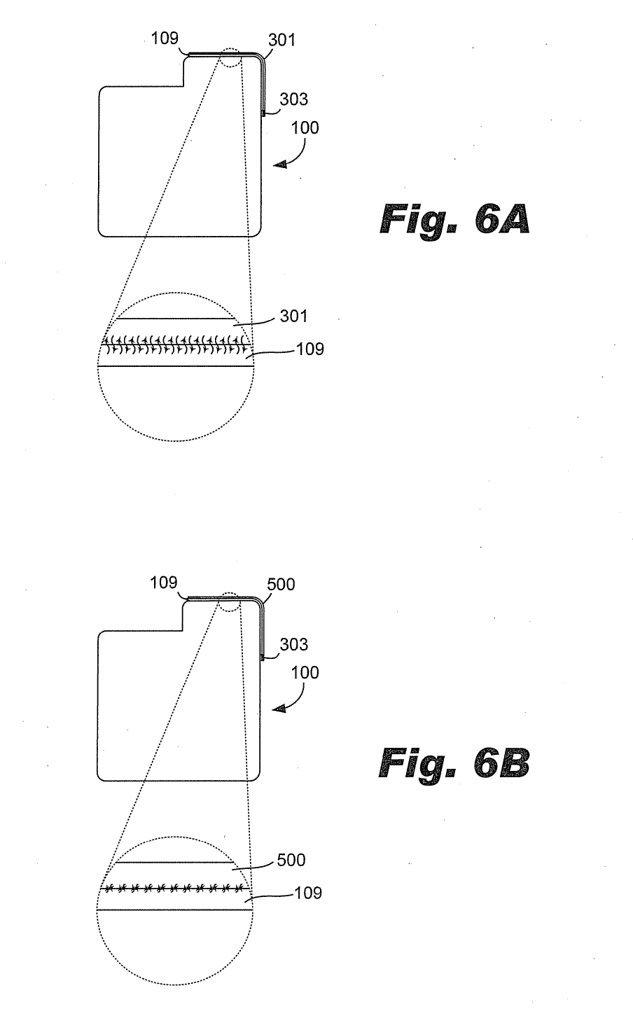

Referring now to FIG. 6A, interfacial diffusion between a prior art adhesive tape (301) and the polymer material (109) of an illustrative print cartridge (100) is shown. The interfacial diffusion may be affected by the chemical adhesion properties between the adhesive material in the tape (301) and the polymer material (109). As illustrated in the present example, particles from the adhesive tape (301) may diffuse across the interface of the adhesive tape (301) and into the polymer material (109) of the print cartridge (100). Likewise, particles from the polymer material (109) of the print cartridge (100) may diffuse across the interface into the adhesive tape (301).

This interfacial diffusion may form a region (illustrated by the arrows) extending from the interface of the polymer material (109) of the print cartridge (100) and the adhesive tape (301) into each of the polymer material (109) of the print cartridge (100) and the adhesive tape (301). In tape using EVA adhesive, it was found that the interfacial diffusion was affected by the percentage of vinyl acetate in the adhesive material, the melt index of the adhesive material, and the amount of cross-linking between polymer particles in the adhesive material.

Referring now to FIG. 6B, the print cartridge (100) is shown with the new adhesive tape (500) of the present specification applied over the polymer material (109). The adhesive tape (500) may include an EVA adhesive deposited on a basefilm at a thickness of 18 microns (0.7 mils) or less. The adhesive material may include at least 28% by weight vinyl acetate, a melt index of at least 20 g/10 min., and have been irradiated at a level of at least 110 kGy (11 MRad) to induce cross-coupling between the polymer particles of the EVA.

As shown in FIG. 6B, the amount of interfacial diffusion between the adhesive tape (500) and the polymer material (109) of the print cartridge (100) may be greatly reduced in comparison to the amount of interfacial diffusion shown in FIG. 6A. This reduced level of interfacial diffusion may substantially reduce unwanted increases in the adhesion between the adhesive tape (500) and the polymer material (109) of the print cartridge (100) over time. By preventing the tape from more strongly adhering over time, we are able to help prevent tearing or structural damage to the polymer material (109) of the print cartridge (100) when the adhesive tape (500) is removed from the polymer material (109) of the print cartridge (100).

### Example

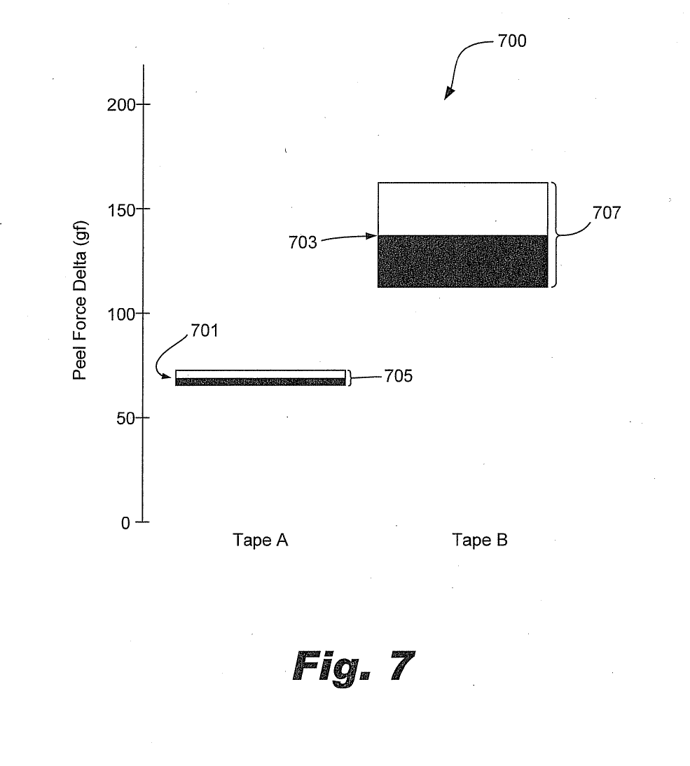

Referring now to FIG. 7, an adhesive tape according to the principles of the present specification (Tape A) and a prior art adhesive tape (Tape B) were applied under substantially identical conditions to substantially identical SU8 photoresist substrates printhead components of inkjet print cartridges. Tape A included a 12.7 micron (0.5 mil) thick layer of EVA adhesive having 28% by weight vinyl acetate, a melt flow index of 25 g/10 min., and that had been cured by irradiation at a level of 120 kGy (12 MRad).

In contrast, Tape B included a 38.1 micron (1.5 mil) thick layer of EVA adhesive having 25% vinyl acetate, a melt flow index of 2 g/10 min, and had been cured by irradiation at a level of 50 kGy (5 MRad).

The peel forces required to remove the tapes from the polymer substrates were compared. The experiment was repeated several times, and the average results of the peel force delta (maximum peel force minus the minimum peel force) measurements are shown in the graph (700). The peel force delta measurement is essentially an indirect measure of adhesion uniformity across the photoresist substrates.

As shown in the graph (700), Tape A exhibited a mean peel force delta (701) of approximately 73 gram-force (gf), which was substantially lower than the mean peel force delta (703) of Tape A, which was approximately 135 gf. Additionally, the standard deviation (705) from the mean peeling force delta (701) of Tape A was measured at approximately 14 gf, compared with the approximately 50 gf measured as the standard deviation (707) for the mean peeling force delta (703) of Tape B.

Thus, it can be concluded that Tape A exhibited a much more uniform and predictable adhesion to the photoresist substrates than that of Tape B.

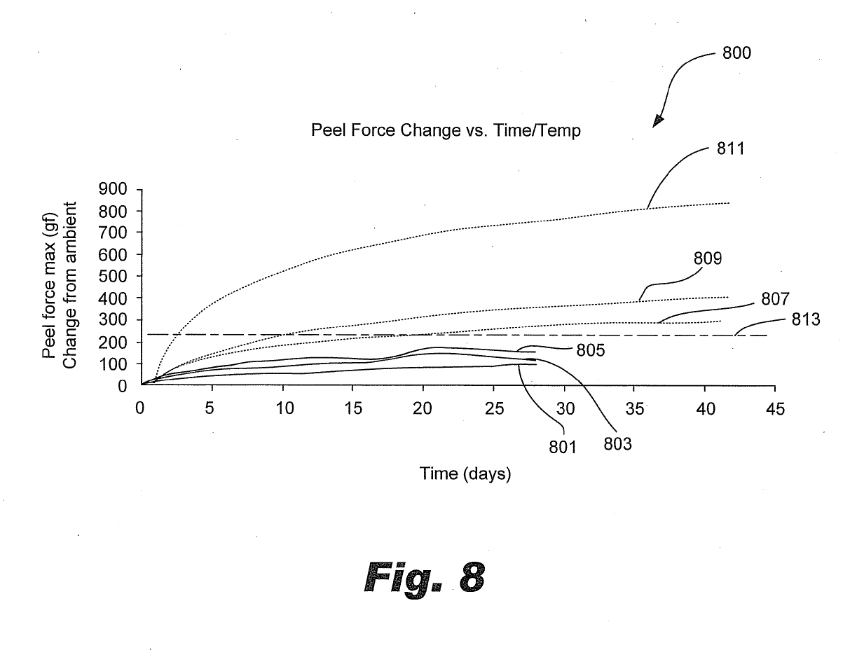

Referring now to FIG. 8, Tape A and Tape B were again applied to substantially identical SU8 printhead substrates. Then, the respective peel forces required to remove the tapes from the substrates at different temperatures and after different lengths of time was plotted on a graph (800).

The solid plots (801, 803, 805) in the graph (800) correspond to the peel forces measured over time for Tape A at constant temperatures of 45° C., 50° C., and 60° C., respectively. The dashed plots (807, 809, 811) correspond to the peel forces measured over time for Tape B at constant temperatures of 45° C., 50° C., and 60° C., respectively.

As shown in FIG. 8, the peel force response curves for the tapes are substantially logarithmic. The plots (801, 803, 805) corresponding to Tape A are generally flatter and of lower values than the plots (807, 809, 811) corresponding to Tape B.

A measured critical peel force threshold (813) is also shown on the graph. Tearing and/or other structural damage to the SU8 photoresist substrate was observed to be much more likely once this critical peel force threshold (813) had been surpassed by an adhesive tape. As shown in FIG. 8, over all measured time periods and temperature levels, Tape A was never observed to surpass the critical peel force threshold (813), while Tape A was observed to surpass the critical peel force for temperature levels of 45° C., 50° C., and 60° C. at approximately 17 days, 10 days, and 3 days, respectively.

### Illustrative Methods

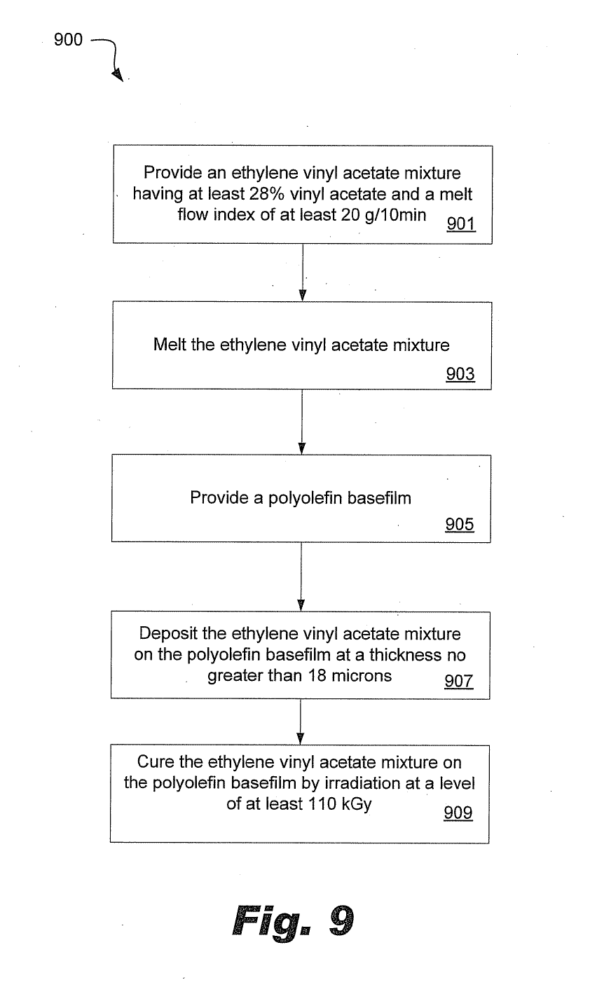

Referring now to FIG. 9, a flowchart of an illustrative method (900) of fabricating an adhesive tape is shown. The adhesive tape may be used in conjunction with a polymer substrate. In certain embodiments, the adhesive tape produced by the method (900) may be used to temporarily plug one or more orifices in the polymer substrate. For example, the adhesive tape may be employed to seal orifices in an inkjet printhead formed in a photoresist or other polymer on a print cartridge.

The method (900) may include providing (step 901) an ethylene vinyl acetate mixture having at least 28% by weight vinyl acetate and a melt flow index of at least 20 g/10 min. Between 65% and 72% of the mixture may include ethylene.

The ethylene vinyl acetate mixture may be melted (step 903) and a polyolefin basefilm may then be provided (step 905). The melted ethylene vinyl acetate mixture may then be deposited (step 907) on the polyolefin basefilm at a thickness no greater than 18 microns (˜0.7 mils).

After deposition, the ethylene vinyl acetate mixture may be cured (step 909) by irradiation at a level of at least 110 kGy (11 MRad). This may be done using an electron beam or any other suitable means as may suit a particular application of the principles described herein. The irradiation may cause at least some of the ethylene vinyl acetate particles in the mixture to cross-couple, thereby forming ethylene vinyl acetate copolymer particles.

The preceding description has been presented only to illustrate and describe embodiments and examples of the principles described. This description is not intended to be exhaustive or to limit these principles to any precise form disclosed. Many modifications and variations are possible in light of the above teaching.

1. An adhesive tape, comprising an adhesive material having at least 28% vinyl acetate by weight disposed on a basefilm at a substantially uniform thickness of up to 18 microns.

2. The adhesive tape of claim 1, wherein said adhesive material comprises at least 65% ethylene.

3. The adhesive tape of claim 1, wherein said adhesive material has been cured by irradiation at a level of at least 110 kGy.

4. The adhesive tape of claim 1, wherein said adhesive material comprises a melt index of at least 20 g/10 min.

5. The adhesive tape of claim 1, wherein at least a portion of said adhesive material comprises a cross-linked ethylene vinyl acetate copolymer.

6. The adhesive tape of claim 1, wherein said basefilm comprises polyolefin.

7. A system, comprising:
a polymer substrate; and
a piece of tape adhering to said polymer substrate;
wherein said piece of tape comprises an adhesive material having at least 28% vinyl acetate by weight disposed on a basefilm at a substantially uniform thickness of up to 18 microns.

8. The system of claim 7, wherein said polymer substrate comprises an orifice.

9. The system of claim 8, wherein said adhesive tape is disposed over said orifice and configured to seal said orifice.

10. The system of claim 9, further comprising an inkjet printhead that incorporates said polymer substrate.

11. The system of claim 7, wherein said adhesive material comprises at least 65% ethylene.

12. The system of claim 7, wherein said adhesive material has been cured by irradiation at a level of at least 110 kGy.

13. The system of claim 7, wherein said adhesive material comprises a melt index of at least 20 g/10 min.

14. The system of claim 7, wherein at least a portion of said adhesive material comprises a cross-linked ethylene vinyl acetate copolymer.

15. The system of claim 7, wherein said basefilm comprises polyolefin.

16. A method of fabricating an adhesive tape, comprising depositing an adhesive material comprising at least 28% vinyl acetate by weight on a basefilm at a substantially uniform thickness of up to 18 microns.

17. The method of claim 16, wherein said adhesive material comprises at least 65% ethylene.

18. The method of claim 16, further comprising irradiating said adhesive material at a level of at least 110 kGy prior to depositing said adhesive material on said basefilm.

19. The method of claim 16, wherein at least a portion of said adhesive material comprises a cross-linked ethylene vinyl acetate copolymer.

20. The method of claim 16, wherein said adhesive material comprises a melt index of at least 20 g/10 min.
